(19) United States
(12) Patent Application Publication
(10) Pub. No.: US 2022/0274241 A1
(43) Pub. Date: Sep. 1, 2022

(54) SPRING HAMMER FOR RAPPING A SURFACE

(71) Applicant: Sumitomo SHI FW Energia Oy, Espoo (FI)

(72) Inventor: Rauno Peippo, Varkaus (FI)

(21) Appl. No.: 17/635,132

(22) PCT Filed: Aug. 29, 2019
(86) PCT No.: PCT/EP2019/073156

§ 371 Date: Feb. 14, 2022

(51) Int. Cl. B25D 17/06; F28G 7/00; B08B 7/02

(52) U.S. Cl. CPC B25D 17/06; F28G 7/00; B08B 7/02; B25D 2217/0015; B25D 2217/0023; B25D 2250/371

(57) ABSTRACT

A spring hammer for rapping a surface, the spring hammer includes an anvil with an impact surface. The anvil can fastened to the surface to be rapped. A movable piston has a first end that is in operation moved towards the impact surface of the anvil. A guiding structure guides the piston to move in a defined direction with respect the anvil and a device for launching the piston to move the piston towards the impact surface of the anvil. The piston is a solid block in which the first end of the piston is machined to an integrated flexible spring geometry.

### BACKGROUND OF THE INVENTION

### Field of the Invention

The present invention relates to a spring hammer device being applicable, for example, for removing fouling from heat surfaces, plate structured funnels or channels of steam boilers or heat recovery tubes for pyrometallurgical processes. Thus, the invention especially relates to an apparatus comprising an anvil with an impact surface, which anvil can be fastened to the surface to be rapped, a movable piston having a first end that is in operation moved towards the impact surface of the anvil, a guiding structure for guiding the piston to move in a defined direction with respect to the anvil, and a device for launching the piston to move the piston towards the impact surface of the anvil.

### Description of Related Art

The fouling of the surfaces can disturb the operation of the plant in question in many ways. For example, the fouling of heat recovery tubes decreases their heat exchange efficiency and thus decreases the performance of the process. At the same time, the fouling increases the temperature of the flue gas and causes disadvantageous results in the channels and devices downstream of the heat recovery stage. On the other hand, for example, the dirt stuck on the surfaces of the flue gas channel can considerably increase the flow resistance of the flue gas, which increases the auxiliary power of the boiler. At its worst, the dirt can even clog channels and thus cause shutdowns of the plant. Fouling surfaces can be cleaned, for example, by means of steam or pneumatic sootblowers or sonic sootblowers. Especially, in very heavily fouling processes including chemically reacting, sticky, melt or semi-melt dust particles or condensing gas components, also mechanical spring hammers are used for cleaning surfaces. By such devices, the surface is subjected to hits in order to cause therein rapid, small amplitude vibration. This way, it is possible to have the impurities stuck on the surfaces loosen effectively without causing excessive mechanical stresses on the surface.

U.S. Pat. No. 4,974,494 discloses a pneumatic knocking device, comprising a cylindrical housing with a bottom plate to be fastened to the surface to be knocked. The housing encloses an elongate spring chamber with a spring for launching a piston against a bottom surface of the housing. The piston is movable towards a top wall of the housing by means of compressed air against the pressure of the spring, and a quick-acting vent valve vents the chamber beneath the piston so that the piston produces a blow against the bottom surface. A problem with this device is that the hard blows may damage the piston or other parts of the device.

U.S. Pat. No. 3,835,817 discloses a hammer system for cleaning boiler tubes, the hammer system having a pair of disk springs resiliently attached to the striking end thereof and mounted in relationship to the tubes to exert a mechanical impulse thereon by striking the desired point of impulse, the frequency of the impulse being in the range of two hundred Hertz to two thousand Hertz.

European patent EP 2102577 B1 discloses a spring hammer comprising a cylindrical housing, a piston arranged to be movable in the housing, an anvil, a spring for launching the piston to move against an impact surface of the anvil, and a spring bank consisting of a pair of disk springs arranged between the piston and the impact surface of the anvil. The spring bank slows down to a certain extent the deceleration of the hammering movement, and thus decreases the forces and stresses, and the risk of damaging the hammer and the anvil. The spring constant of the spring bank is preferably such that the maximum deceleration of the piston is on the order five hundred grams to one thousand grams. It has been proven in practice that, to a certain extent, such decelerated impact also removes impurities more efficiently from the surfaces to be rapped than a completely inflexible impact. A problem with a conventional spring bank is that the disk springs and spring fixing elements may in some conditions break or loosen during operation.

An object of the present invention is to provide an efficient spring hammer for fouling surfaces, in which the problems of the prior art devices described above have been minimized.

### SUMMARY OF THE INVENTION

According to one aspect, the present invention provides a spring hammer for rapping a surface, the spring hammer comprising an anvil with an impact surface, which anvil can be fastened to the surface to be rapped, a movable piston having a first end that is in operation moved towards the impact surface of the anvil, a guiding structure for guiding the piston to move in a defined direction with respect to the anvil, and a device for launching the piston to move the piston towards the impact surface of the anvil, wherein the first end of the piston or the impact surface of the anvil is machined to form an integrated flexible spring geometry.

In operation of the spring hammer, the piston exerts hits to the anvil and the impact surface is the surface of the anvil that takes the hits from the piston. The defined direction is generally the normal of the impact surface at the point in which the hits are exerted. The direction may also be called the hammering axis of the anvil. In other words, when the first end of the piston is machined to form the integrated flexible spring geometry, the impact surface will take impacts from the piston wherein the first end, which is in operation moved towards the impact surface of the anvil, will then be in direct contact with the impact surface. Specifically, during the impact the flexible spring geometry of the piston will be in direct contact with the impact surface. On the other hand, when the impact surface of the anvil is machined to form the integrated flexible spring geometry, the integrated flexible spring geometry (in the anvil) will take impacts from the first end of the piston, which first end will then be in direct contact with the integrated flexible spring geometry (in the anvil) during the impact.

The guiding structure has advantageously such a cylindrical shape that all inclined or traverse movements of the piston are prevented. The guiding structure is attached to the anvil in order to guarantee the desired moving direction of the piston with respect to the anvil. Attachment of the guiding structure to the anvil is advantageously to a certain extent flexible in the direction of the hammering axis to dampen the effect of the hits to the guiding structure. By such an arrangement, it is possible to maintain the movement of the piston in the right direction at the same time as the impact of the hit is dampened from transferring to the guiding structure.

The hammering movement of a spring hammer can be provided, for example, pneumatically or by means of electromagnets. In order to create the hammering movement, the means to be used comprise, however, preferably, a spring, which is tensioned by means of a tensioning device through an appropriate drive means. The tensioning of the spring can preferably be released by using an adjustable releasing mechanism at a desired tensioning level, whereby the released hammer hits at a great speed towards the impact surface of the anvil.

The spring is preferably arranged between supporting surfaces associated with the piston and the anvil, preferably, in such a way that, when tensioning, the spring is compressed or extended in the direction of the hammering axis and when released it returns to its original length. In order for the size of the spring hammer to be maintained small, the strokelength of the hammer is preferably relatively short. However, the strokelength is preferably so long that the hammer may achieve a sufficient speed with a reasonable acceleration, preferably one to five grams, most preferably, with an acceleration of two to three grams. Thereby, the reaction force caused on the supporting surface of the anvil of the spring remains relatively small and the durability of the supporting surface of the anvil improves.

The spring force of the spring must be dimensioned such that the desired acceleration is achieved by a chosen hammer weight, which is typically thirty kilograms to forty kilograms. For example, in order to achieve the initial acceleration of 2.5 g, the spring force must then be, as tensioned, seven hundred fifty Newtons to one thousand Newtons. The spring is preferably chosen in such a way that even at the end of the impact, there is still more spring force left than the weight of the hammer, for example, four hundred Newtons to five hundred Newtons, whereby the hammer of the spring hammer does not move in the transportation nor in the assembly, and it has a stable rest position also when the direction of the impact is upwards, for example, to the outer surface of the bottom of a funnel.

The tensioning device of the spring may preferably be, for example, a motor, a pneumatic or a hydraulic cylinder or an electromagnet. At least the most sensitive parts of the tensioning device, for example, the motor and its gears, are not supported, in accordance with a preferred embodiment of the invention, from the anvil, but they are separately supported by an external supporting structure. Thereby, the vibrations of the anvil do not transfer to the sensitive parts of the tensioning device and the risk of them getting broken diminishes. The driving mechanism of the tensioning device must then be flexibly floating or it must otherwise allow the moving of the spring hammer due to the thermal movements of the surface to be rapped.

According to a conventional solution, a so-called spring bank is arranged between the piston and the anvil, in other words, an element that is flexible, with a high spring constant, in the direction of the hammering axis. The conventional spring bank is a pair of rigid disk springs. The spring bank slows down to a certain extent the deceleration of the hammering movement, and thus decreases the forces and stresses, and the risk of damaging the hammer and the anvil. The spring constant of the spring bank is preferably such that the maximum deceleration of the piston is on the order five hundred to one thousand grams. It has been proven in practice that, to a certain extent, such decelerated impact also removes impurities more efficiently from the surfaces to be rapped than a completely inflexible impact.

The present invention differs from the conventional solution in that the assembly of the spring bank and piston, or the anvil and spring bank, is replaced by a solid block in which, to the first end of the piston or to the impact surface of the anvil, is machined to form an integrated flexible spring geometry to replace the separate spring bank. Thereby, the whole solid block piston or the anvil with the integrated flexible spring geometry can be obtained by machining. This has the effect that a conventional spring bank can be omitted and the problems relating to a separate spring bank are largely removed. Furthermore, the reduced amount of individual parts will extend the lifetime and the need for service of the spring hammer in which the piston or the anvil assembly with the integrated flexible spring geometry is a solid block. By using specially prepared lathing tools and by carefully analyzing machined results, it is possible to achieve a flexible spring geometry having desired properties.

The spring hammer preferably comprises a curved hollow part integrated to an end of a solid block part. The curved hollow part can be carved, e.g., by lathing tools, to form a hollow part having, for example, a bowl-like shape. The curved hollow part has an open free end. In case the flexible spring geometry is part of the hammer, the open free end is arranged into that end of the integrated flexible spring geometry that will be facing the impact surface during the impact. In case the flexible spring geometry is part of the impact surface of the anvil, the open free end is arranged into that end of the integrated flexible spring geometry that will be facing the first end of the hammer.

In a case of the curved hollow part being integrated to an end of a solid block part, an angle on an outer surface of the first end between the piston and the integrated flexible spring geometry is advantageously ten degrees to sixty degrees for a predefined distance.

According to an embodiment of the invention, the flexible spring geometry in the first end of the piston can be in indirect contact with the impact surface so that, between the flexible spring geometry and the impact surface of the anvil, there is located an intermediate element for transferring the impact forces or the flexible spring geometry in an impact surface of the anvil can be in indirect contact with the first end of the hammer so that, between the flexible spring geometry and the first end of the anvil, there is located an intermediate element for transferring the impact forces.

The movement of the hammer of a spring hammer in accordance with the present invention is directed in the manufacturing stage to be parallel to a hammering axis of the anvil. The spring hammer does thus not require aligning between the anvil and the hammer when assembling the device or realigning, for example, when increasing the temperature of the heat exchange tubes to be rapped. The apparatus eliminates thus the bending moment against the anvil due to an incorrect aligning of the hammer and the damage of the anvil due to that as well as the damage of the joint connecting the anvil to the surface to be rapped. A correctly aligned impact also improves the transfer efficiency of the impact to the surface to be rapped.

The spring hammer is simple in structure and may be preassembled already in the manufacturing stage. This simplifies the assembly of the apparatus and decreases the costs of the apparatus as well as the maintenance need thereof. The apparatus is a compact unit, which may be easily noise-shielded and assembled to any position needed. In the practical applications, there is usually a large number of spring hammers, which can be completely separate or they may have, for example, a common pneumatic tensioning device, which guides the rapping pulses in a suitable sequence to different spring hammers. Owing to the small size and low weight, they can be assembled even to narrow spaces and also close to each other, if necessary.

### BRIEF DESCRIPTION OF THE DRAWINGS

The invention is described below with reference to the accompanying drawings, in which

FIGS. 1 to 3 schematically illustrate cross sections of different spring hammers in accordance with the present invention.

FIG. 1 illustrates a spring hammer 10 in accordance with a preferred embodiment of the present invention. The spring hammer comprises an anvil 12 with an impact surface 14 at one end of the anvil. The other end of the anvil is attached by means of a welded seam 16 to a hammering beam 18. If the wall to be rapped is, for example, an outer wall of a reactor, channel or funnel, the other end of the hammering beam 18, which is not seen in FIG. 1, may be welded to the wall. Alternatively, in such a case, a separate hammering beam 18 may not be necessary, but the anvil 12 may be attached directly to the wall to be rapped. If, in turn, there are, for example, heat exchange tube banks in a gastight space of a reactor or a steam boiler are to be rapped, the hammering beam 18 may be flexibly sealed to the wall of the gas space and welded to the heat exchange tubes or their connecting piece. Since the different sealing and attaching methods of the hammering beam are of a known technique, they will not be described below in detail.

The spring hammer comprises a movable piston 20 having a first end 22 with a flexible spring geometry. The flexible spring geometry advantageously comprises a curved hollow part with an open free end, integrated to a solid portion of the anvil. The first end is in operation moved towards the impact surface 14 of the anvil.

Material of the piston is advantageously high quality tempering steel to suit for spring use and the required machining. However, a large range of materials can be suitable, as long as they tolerate the reasonable cyclic tensile and compressive loads, and are easy enough to machine properly.

The spring hammer also comprises a cylindrical vessel 24 acting as a guiding structure that allows the piston 20 to move only in a defined direction with respect to the anvil. The cylindrical vessel is attached to the anvil 12, for example, by bolts 26. The bolts are mounted in place by using suitable flexible elements, such as flexible bushings 27, to dampen the effect of the hits to the guiding structure. The bolts 26 are herein arranged perpendicular to the hammering direction, but they could alternatively be arranged through a suitable flange, as is clear to a person skilled in the art of connecting pieces, in the direction of or opposite to the hammering direction. In such cases, the flexible elements are advantageously springs, such as suitable disc springs.

The second end of the piston 20, opposite to the first end of the piston, is attached to an end plate 28. The end plate 28 is arranged outside an outer end 29 of the cylindrical vessel 24. Multiple extension springs 30, such as four extension springs, are arranged between a flange 32 in the cylindrical vessel 24 and the end plate 26.

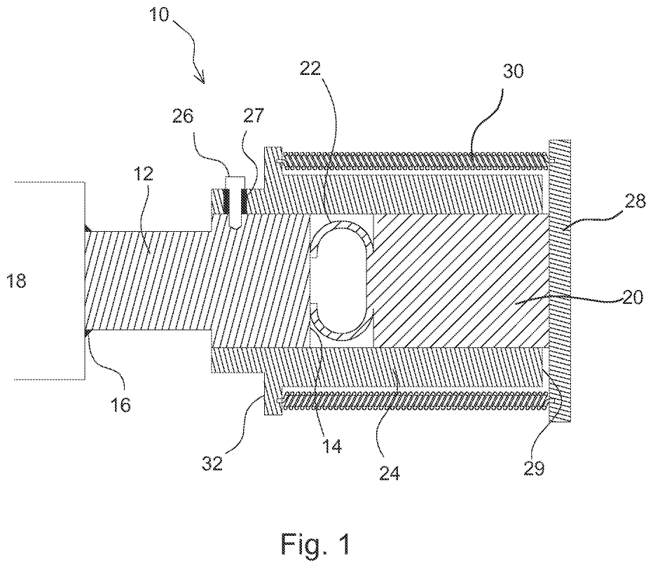

The spring hammer 10 in FIG. 1 is illustrated in an impact position, in other words, in a position, in which the springs 30 are in their minimum length and the first end 22 with a flexible spring geometry of the piston 20 is in contact with the anvil 12. When using the spring hammer, the springs 30 are tensioned by drawing the piston 20 outwards by a suitable tensioning device. The tensioning device, not shown in FIG. 1, is usually pneumatic, but it may alternatively be, for example, electromagnetic or be, based on using a separately supported motor. Thus, in operation, the piston 20 is first excited by moving the piston further from the anvil, after which, the springs 30 are released so as to launch the piston to move towards the impact surface 14 of the anvil. When the springs 30 are tensioned to a desired tension, the impact is caused by releasing the springs whereby the first end 22 of the piston 20 hits at a high speed to the impact surface 14 of the anvil 12. Since the direction of the hammer movement of the hammer 18 is defined by the guiding means, i.e., the cylindrical vessel 24, the impact is always appropriately directed relative to the anvil.

The flexible spring geometry at the first end 22 of a movable piston 20 has advantageously a high spring constant so as to dampen the stopping of the piston 20. The flexible spring geometry extends the duration of a single impact without substantially diminishing the total amount of the hammering energy. According to an exemplary solution, the deceleration of the hammer movement is, preferably, at most on the order of one thousand grams.

The strokelength, in other words, the change in the length of the spring to be utilized when using the apparatus, is preferably fifty millimeters to one hundred millimeters, such as sixty mm. According to a preferred embodiment, the mass of the hammer is about forty kg, the spring force at maximum tension about one thousand Newtons and at the end of the impact still about five hundred Newtons. Thereby the initial acceleration of the impact is twenty-five m/s² and the impact energy one hundred twelve Nm. By adjusting the strokelength of the spring hammer, it is naturally possible to adjust the strength of the impact. The advantageous values of the parameters of the spring hammer depend on the application when the spring hammer is used, so they may deviate a lot from the exemplary values described above.

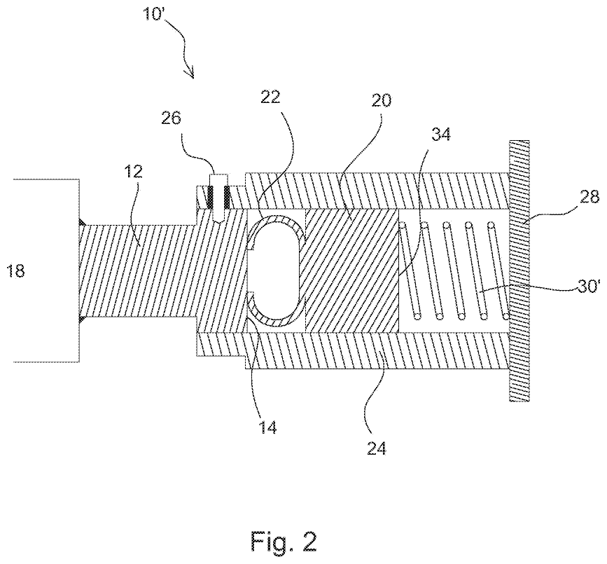

In FIG. 2, which illustrates another preferred embodiment of the spring hammer in accordance with the invention, the parts corresponding to those illustrated in FIG. 1 are disclosed with the same reference numbers as in FIG. 1.

FIG. 2 illustrates a spring hammer 10′ in accordance with a second preferred embodiment of the present invention. The spring hammer 10′ differs from spring hammer 10 shown in FIG. 1 mainly in that the extension springs 30 are replaced by a compression spring 30′ that is arranged between a second end 34 of the piston and the end plate 26. Thus, the spring 30′ is tensioned by compressing it by suitable means, such as pneumatically, towards the end plate 26. Otherwise, the operation of the spring hammer 10′ corresponds to that of spring hammer 10 shown in FIG. 1.

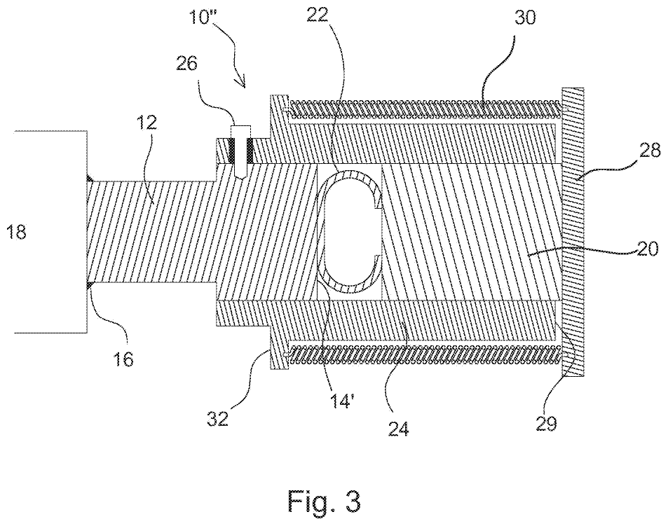

FIG. 3 illustrates a spring hammer 10″ in accordance with a third preferred embodiment of the present invention. The spring hammer 10″ differs from spring hammer 10 shown in FIG. 1 in that a flexible spring geometry 22 is arranged at the impact surface 14′ of the anvil instead of the first end of the piston 20. Thus, the flexible spring geometry is not moving with the piston, but it stays with the anvil, i.e., it is not movable in the operation of the spring hammer. Such a flexible spring geometry, however, has the same effect to dampen the hits of the piston as the solutions described above. An anvil with a flexible spring geometry arranged at the impact surface 14′ of the anvil can naturally also be arranged to a spring hammer with a compression spring, as shown, for example, in FIG. 2.

According to a further aspect of the present invention, a piston with a first end machined to form an integrated flexible spring geometry, as shown in FIGS. 1 and 2, or an anvil with an impact surface machined to form an integrated flexible spring geometry, as shown in FIG. 3, can be a separate product, for example, a spare part to an existing spring hammer.

The present invention is described above with reference to an exemplary embodiment, but the invention also comprises many other embodiments and modifications. It is thus evident that the disclosed exemplary embodiment is not intended to restrict the scope of invention, but the invention comprises a number of other embodiments that are limited by the accompanying claims and the definitions therein alone.

1. A spring hammer for rapping a surface, the spring hammer comprising:
an anvil with an impact surface, which anvil can be fastened to the surface to be rapped;
a movable piston having a first end that is in operation moved towards the impact surface of the anvil;
a guiding structure for guiding the piston to move in a defined direction with respect to the anvil; and
a device for launching the piston to move the piston towards the impact surface of the anvil,
wherein the first end of the piston or the impact surface of the anvil is machined to form an integrated flexible spring geometry.

2. A spring hammer in accordance with claim 1, wherein the spring coefficient of the flexible spring geometry such that the maximum deceleration of the piston is on the order five hundred grams to one thousand grams.

3. A spring hammer in accordance with claim 2, wherein the flexible spring geometry comprises a curved hollow part integrated to an end of a solid block part of the piston.

4. A spring hammer in accordance with claim 2, wherein the flexible spring geometry comprises a curved hollow part integrated to a solid portion of the anvil.

5. A spring hammer in accordance with claim 3, wherein the curved hollow part has an open free end.

6. A spring hammer in accordance with claim 1, wherein the flexible spring geometry is made of high quality tempering steel material.

7. A spring hammer in accordance with claim 1, wherein the device for launching the piston comprises a spring.

8. A spring hammer in accordance with claim 7, wherein the spring is a compression spring.

9. A spring hammer in accordance with claim 7, wherein the spring is an extension spring.

10. A spring hammer in accordance with claim 9, further comprising at least two extension springs, arranged outside the guiding structure.

11. A spring hammer in accordance with claim 7, further comprising a tensioner for tensioning the spring.

12. A spring hammer in accordance with claim 11, wherein the tensioner for tensioning the spring comprises a pneumatic tensioning device.

13. A piston for a spring hammer, the spring hammer comprising:
an anvil with an impact surface, which anvil can be fastened to the surface to be rapped,
a movable piston having a first end that is in operation moved towards the impact surface of the anvil;
a guiding structure for guiding the piston to move in a defined direction with respect to the anvil; and
a device for launching the piston to move the piston towards the impact surface of the anvil,
wherein the first end of the piston or the impact surface of the anvil is machined to form an integrated flexible spring geometry,
and wherein the first end of the piston is machined to form an integrated flexible spring geometry.

14. An anvil piece for a spring hammer, the spring hammer comprising:
an anvil with an impact surface, which anvil can be fastened to the surface to be rapped,
a movable piston having a first end that is in operation moved towards the impact surface of the anvil;
a guiding structure for guiding the piston to move in a defined direction with respect to the anvil; and
a device for launching the piston to move the piston towards the impact surface of the anvil,
wherein the first end of the piston or the impact surface of the anvil is machined to form an integrated flexible spring geometry,
and wherein the impact surface of the anvil piece is machined to form an integrated flexible spring geometry.

15. A spring hammer in accordance with claim 13, wherein the spring coefficient of the flexible spring geometry such that the maximum deceleration of the piston is on the order five hundred grams to one thousand grams.

16. A spring hammer in accordance with claim 15, wherein the flexible spring geometry comprises a curved hollow part integrated to an end of a solid block part of the piston.

17. A spring hammer in accordance with claim 15, wherein the flexible spring geometry comprises a curved hollow part integrated to a solid portion of the anvil.

18. A spring hammer in accordance with claim 16, wherein the curved hollow part has an open free end.

19. A spring hammer in accordance with claim 13, wherein the flexible spring geometry is made of high quality tempering steel material.

20. A spring hammer in accordance with claim 13, wherein the device for launching the piston comprises a spring.

21. A spring hammer in accordance with claim 20, wherein the spring is a compression spring.

22. A spring hammer in accordance with claim 20, wherein the spring is an extension spring.

23. A spring hammer in accordance with claim 22, further comprising at least two extension springs, arranged outside the guiding structure.

24. A spring hammer in accordance with claim 20, further comprising a tensioner for tensioning the spring.

25. A spring hammer in accordance with claim 24, wherein the tensioner for tensioning the spring comprises a pneumatic tensioning device.

26. A spring hammer in accordance with claim 14, wherein the spring coefficient of the flexible spring geometry such that the maximum deceleration of the piston is on the order five hundred grams to one thousand grams.

27. A spring hammer in accordance with claim 26, wherein the flexible spring geometry comprises a curved hollow part integrated to an end of a solid block part of the piston.

28. A spring hammer in accordance with claim 26, wherein the flexible spring geometry comprises a curved hollow part integrated to a solid portion of the anvil.

29. A spring hammer in accordance with claim 27, wherein the curved hollow part has an open free end.

30. A spring hammer in accordance with claim 14, wherein the flexible spring geometry is made of high quality tempering steel material.

31. A spring hammer in accordance with claim 14, wherein the device for launching the piston comprises a spring.

32. A spring hammer in accordance with claim 31, wherein the spring is a compression spring.

33. A spring hammer in accordance with claim 31, wherein the spring is an extension spring.

34. A spring hammer in accordance with claim 32, further comprising at least two extension springs, arranged outside the guiding structure.

35. A spring hammer in accordance with claim 31, further comprising a tensioner for tensioning the spring.

36. A spring hammer in accordance with claim 35, wherein the tensioner for tensioning the spring comprises a pneumatic tensioning device.
